(19) United States
(12) Patent Application Publication
(10) Pub. No.: US 2010/0033108 A1
(43) Pub. Date: Feb. 11, 2010

(54) LIGHT CONTROL DEVICE

(76) Inventor: Sergey Yu. Mironichev, Moscow (RU)

Correspondence Address: HOUSTON ELISEEVA, 4 MILITIA DRIVE, SUITE 4, LEXINGTON, MA, 02421, US

(21) Appl. No.: 12/537,111

(22) Filed: Aug. 6, 2009

Related U.S. Application Data
(63) Continuation of application No. PCT/RU2008/000508, filed on Aug. 7, 2008.

(51) Int. Cl. H05B 41/36

(52) U.S. Cl. 315/291

(57) ABSTRACT

This invention refers to electricity and can be applied for wire and wireless remote control (RC) of target illumination equipment or different lights, for example tactical under-barrel light or laser designator mounted on small arms. The technical results achieved at application of the invention are the following: application of light remote power on/off, application of light brightness remote control, application of light lamp battery power-safe mode, application of light operation modes remote control. The essence of the invention is in the fact that the light control device consists of electronic tailcap circuit and remote control device circuit. The electronic tailcap circuit includes light lamp, light lamp battery, electronic switch, voltage stabilizer, voltage devisor, analog-to-discrete converter of the electronic tailcap circuit, electronic tailcap circuit microcontroller, electronic tailcap circuit memory module, electronic tailcap circuit control button, electronic tailcap circuit radio transceiver, electronic tailcap circuit antenna. The remote control device circuit includes: remote control device circuit battery, remote control device circuit control button, remote control device circuit analog-to-discrete converter, remote control device circuit microcontroller, remote control device circuit memory module, remote control device circuit radio transceiver, remote control device circuit antenna.

### RELATED APPLICATIONS

This application is a Continuation of International Application No. PCT/RU2008/000508 filed Aug. 7, 2008, which is incorporated herein by reference in its entirety.

### FIELD OF THE INVENTION

This invention refers to electricity and can be applied for wire and wireless remote control (RC) of target illumination equipment or different lights, for example tactical under-barrel light or laser designator mounted on small arms.

### BACKGROUND OF THE INVENTION

The switch for providing power to filament lamp in a gun target illumination device is known. It contains a gun-mounted frame and reflector element with filament lamp installed in it (SU 859751, MIIK F 21M 1/00, published 5 Sep. 1981) Application of external light control button is not provided in this device.

The out-of-frame fastened under the belt switch in a gun target illumination device, containing reflector element with filament lamp fastened through magazine at the gun barrel is also known (SU 644996, MIIK F 21M 1/00, published 30 Jan. 1979).

In this target illumination device the button is out-of-frame, but securely fixed: there is no availability to place it in any position convenient for shooter. It is not always convenient for illumination power on/off when shooting especially using long-barreled gun as it requires changing of fingertip prehension.

Also there is a unified remote control system including base device and remote control device. The system provides remote signalization of base device charge level and performing search of remote control device (see U.S. Pat. No. 6,879,254, MIIK G 08 B 21/24, published 12 Apr. 2005).

This system does not provide remote control of self-contained power supply equipment and remote control commands confirmation as well.

The closest analogue of it is the light control device containing external button for providing power supply to the lamp in gun target illumination device. It is implemented with the availability to be placed in any place convenient for shooter, thus this device contains external control button with fastener, a wire and a coupling (RU 66601 U1, MIIK H 01 H27/00, published 10 Sep. 2007).

One of the main disadvantages of the system being the closest analogue is the presence of additional wires connecting the button to the light. Another disadvantage of the system being the closest analogue is the non ability to estimate the battery charge level.

### SUMMARY OF THE INVENTION

The overall purpose of this invention is to eliminate disadvantages of the prototype product. To be more exact, the purposes are as following: light remote power on/off; light brightness remote control; light lamp power supply efficient use; light operation modes remote control; extension of light control device functional availabilities.

The essence of the invention is in the fact that the light control device contains electronic tailcap circuit and remote control device circuit, more to that the electronic tailcap circuit includes light lamp, light lamp battery, electronic switch, voltage stabilizer, voltage devisor, analog-to-discrete converter of the electronic tailcap circuit, electronic tailcap circuit microcontroller, electronic tailcap circuit memory module, electronic tailcap circuit control button, electronic tailcap circuit radio transceiver, electronic tailcap circuit antenna and the remote control device circuit includes: remote control device circuit battery, remote control device circuit control button, remote control device circuit analog-to-discrete converter, remote control device circuit microcontroller, remote control device circuit memory module, remote control device circuit radio transceiver, remote control device circuit antenna, thus the positive side of the light lamp battery is connected to one of the light lamp contacts, the other contact which is connected to the negative side of the light lamp battery through electric circuit changer, another contact of the light lamp is connected to the input of voltage divisor. Its output is connected to the pulse-duration modulation regulation input of the electronic tailcap circuit microcontroller through electronic tailcap circuit analog-to-digital converter. Electronic tailcap circuit control button is connected to the microcontroller and voltage stabilizer, electronic tailcap circuit microcontroller and voltage divisor are connected to the negative side of the light lamp. More to that the control input of the electronic switch is connected to the control output of the electronic tailcap circuit microcontroller which power input is connected to the voltage stabilizer output. The electronic tailcap circuit microcontroller is connected to the electronic tailcap circuit memory module. The voltage stabilizer input is connected to the voltage divisor power input. The data input/output of the electronic tailcap circuit microcontroller as well as power output are connected to the data input/output and to the electronic tailcap circuit radio transceiver power input correspondingly, which is connected to the transmitting and receiving antenna of the electronic tailcap circuit. Thus the remote control device circuit power battery, remote control device circuit control button, remote control device circuit analog-to discrete converter and remote control device circuit microcontroller are connected in series, microcontroller data input-output and its power output is connected to the input-output and to remote control device circuit radio transceiver power input which is connected to the transmitting and receiving antenna of the remote control device circuit. Thus the remote control device circuit microcontroller is also connected to the negative side of the remote control device circuit battery and the remote control device circuit memory module where the light remote control program is installed. Thus the remote control device circuit antenna is connected with the electronic tailcap circuit antenna through duplex radio channel.

The technical results achieved at application of the invention are the following:

Application of light remote power on/off;

Application of light brightness remote control;

Application of light lamp battery power-safe mode;

Application of light operation modes remote control;

Extension of light power on/off device functional abilities.

The submitted light control equipment consists of two circuits: electronic tailcap circuit and remote control panel circuit.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows the electronic tailcap circuit diagram; and

FIG. 2 shows the remote control panel diagram.

### DETAILED DESCRIPTION OF THE PREFERRED EMBODIMENTS

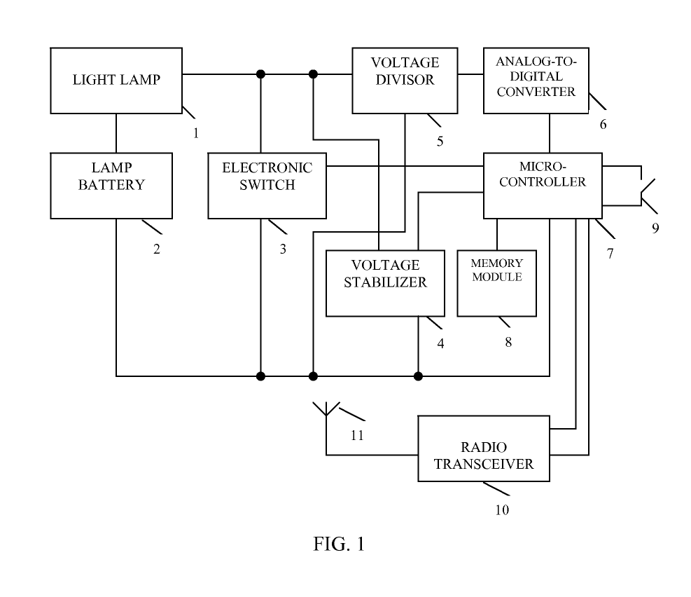

The electronic tailcap circuit diagram including the following items is presented at FIG. 1:

light lamp (1)

light lamp power battery (2)

electronic switch (3)

voltage stabilizer (4)

voltage divisor (5)

electronic tailcap circuit analog-to discrete converter (6)

electronic tailcap circuit microcontroller (7)

electronic tailcap circuit memory module (8)

electronic tailcap circuit control button (9)

electronic tailcap circuit radio transceiver (10)

electronic tailcap circuit antenna (11)

Thus the positive side of the light lamp power battery is connected to one of the light lamp contacts, the other contact is connected to the negative side of the light lamp power battery through electronic switch. The more preferable variant is the connection of the light lamp power battery negative side to the current-conducting frame on which the light is fastened.

The other contact of the light lamp is connected to the voltage divisor input. Its output is connected to the to the pulse-duration modulation regulation input of the electronic tailcap circuit microcontroller through electronic tailcap circuit analog-to-digital converter. The electronic tailcap circuit control button is connected to the microcontroller. The voltage stabilizer, electronic tailcap circuit microcontroller and voltage divisor are connected to the light lamp negative side.

The control input of the electronic switch is connected with control output of the electronic tailcap circuit microcontroller. Its power input is connected to the voltage stabilizer output. More to that the electronic tailcap circuit microcontroller is connected to the electronic tailcap circuit memory module.

Also the voltage stabilizer input is connected to the voltage divisor input.

The electronic tailcap circuit microcontroller data input-output as well as the power output are correspondingly connected to the data input-output and the electronic tailcap circuit radio transceiver power input which is connected to the electronic tailcap circuit transmitting and receiving antenna.

The regular light composition includes light lamp, power supply source and light lamp switcher. In order to achieve the noted technical results in the submitted invention the electronic tailcap circuit includes:

electronic tailcap circuit power stabilizer, electronic tailcap circuit voltage divisor, electronic tailcap circuit AD converter,

electronic tailcap circuit microcontroller, control button and radio transceiver with antenna.

Electronic switch is used as light lamp switcher. The electronic switch is preferably implemented at field transistor. Thus the electronic switch also performs the functions of voltage stabilizer and provides infiltration of cross talk at lamp power on/off.

The voltage stabilizer is intended for automatic voltage maintenance at the electronic tailcap circuit microcontroller input. The voltage stabilizer is energy efficient and low voltage drop and can be applied on the basis of the NJM2871F33 microcircuit manufactured by New Japan Radio.

The voltage divisor is intended for estimation at the light lamp made in resistive type as the voltage values in the circuits of the submitted invention are small. At discharge of the light lamp power battery and receiving of the appropriate voltage value from voltage divisor the electronic tailcap circuit microcontroller generates the light lamp power battery discharge signal. The electronic tailcap circuit microcontroller is the basic element of the submitted invention. The electronic tailcap circuit microcontroller has the following specifications: the 8051 core, 8 kB flash, 1 kB RAM and can be implemented on the basis of CC2510F1 microprocessor manufactured by Texas Instruments.

Functioning of the electronic tailcap circuit microcontroller is performed according to the algorithm of the light control program, which was certified and registered in the Russian Federation under No 2008613773.

This program provides light power on/off at short-time pressing the control button. The program smoothly changes the brightness of the light intensity at pressing and holding of the button.

The program fixes the selected brightness. After pressing and holding the tactile button the program performs actuation of the peak brightness. The switch into the light remote control mode is undertaken by the program after double short-time pressing the button on the tailcap (for signaling of remote control mode actuation the light will flash once). Deactivation of the remote control mode is also undertaken after double short-time pressing the button on the tailcap (for signaling of remote control mode deactivation the light will flash twice).

The light control program is installed in the electronic tailcap circuit memory module, which is connected to the electronic tailcap circuit microcontroller.

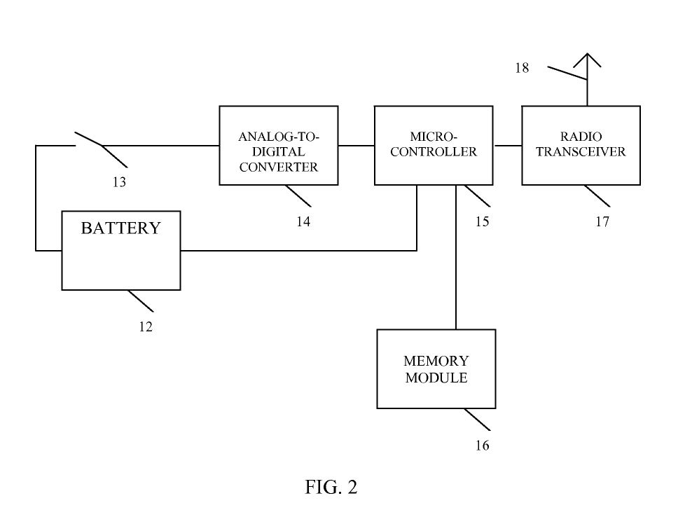

The remote control panel diagram including the following items is presented at FIG. 2:

remote control panel circuit power battery (12);

remote control panel circuit control button (13);

remote control panel circuit analog-to-digital converter (14);

remote control panel circuit microcontroller (15);

remote control panel circuit memory module (16);

remote control panel circuit radio transceiver (17);

remote control panel circuit antenna (18).

The remote control panel circuit contains series connection of remote control panel circuit power battery, remote control panel circuit control button, remote control panel circuit analog-to-digital converter, remote control panel circuit microcontroller which data input-output as well as power output are connected to data input-output and remote control panel circuit radio transceiver power input correspondingly. The radio transceiver is connected to the remote control panel circuit transmitting and receiving antenna. The remote control panel circuit microcontroller is also connected to the negative side of the remote control panel circuit power battery and the remote control panel circuit memory module which contains light remote control program.

The remote control panel circuit microcontroller as well as the electronic tailcap circuit has the following specifications: the 8051 core, 8 kB flash, 1 kB RAM and can be implemented on the basis of CC2510F1 microprocessor manufactured by Texas Instruments.

Functioning of the remote control panel circuit microcontroller is performed according to the algorithm of the light control program, which was certified and registered in the Russian Federation under No 2008613774.

The submitted light control device operates in the following way.

The electronic switch is controlled by the electronic tailcap circuit microcontroller which operates under control of the light control program stored in the electronic tailcap circuit memory module.

At closing the electronic switch the light lamp power battery energy is given to the light lamp and the light switches on.

At opening the electronic switch, the power source energy doesn't come to the light lamp but goes to all other modules and elements of the electronic circuit.

Thus power from the power battery of the light lamp via the electronic switch feeds only the light lamp at one period of time and the rest of electronic tailcap circuit modules the other moment; electronic switch closes the power battery circuit of the light lamp to the light lamp at the very moment pulse-duration modulation signal of switching on the light comes from the electronic tailcap circuit microcontroller.

The light lamp (filament lamp is applicable) is known to be an inertial element, i.e. the lamp power off it goes out not at once, but in a period of time. Correspondingly if voltage is given on the light lamp not constantly (using short pulses), it will glow and will not go out in case the power supply pulse duration is enough.

During the rest of the pulse-duration modulation signal (after the pulse) coming to the electronic switch by the electronic tailcap circuit microcontroller power supply of the rest of the electronic tailcap circuit modules will be undertaken as the lamp circuit will be broken and the light lamp power battery current will come through the voltage stabilizer (used to protect microcontroller from transitional process in the moment of the light lamp power on/off) to the electronic tailcap circuit microcontroller and electronic tailcap circuit radio transceiver, providing power to the modules.

Besides it is obvious that at gradual decreasing the power pulse duration the lamp will gradually glow less brightly for a user.

Thus the light lamp brightness can be controlled by changing pulse-duration modulation signal coming to the electronic switch from the electronic tailcap circuit microcontroller.

Energy-safe operation of the light lamp power battery is also carried out using the method (transferring the power voltage from the light lamp power battery to the light lamp, regulated by the pulse-duration modulation signal from the electronic tailcap circuit microcontroller) as power consumed by the electronic tailcap circuit microcontroller, the electronic tailcap circuit radio transceiver, the voltage stabilizer, the voltage divisor and the electronic tailcap circuit analog-to-digital converter is very low comparing to the capacity consumed by the light lamp.

In case of voltage decrease at the light lamp battery sides to a certain value the appropriate voltage value comes to the electronic tailcap circuit analog-to-digital converter through the voltage divisor. This signal s given to the Through the electronic tailcap circuit microcontroller through the electronic tailcap circuit analog-to-digital converter and the electronic tailcap circuit microcontroller alternates the duration of pulse of the pulse duration modulation signal given to the electronic switch.

Correspondingly at change of pulse duration of pulse duration modulation signal given on the electronic switch the light lamp glowing changes informing that the light lamp battery needs to be replaced.

The remote control panel circuit works on the similar basis. Voltage stabilizer and voltage divisor modules are absent as the remote control panel circuit battery supplies only the the remote control panel circuit microcontroller, the remote control panel circuit radio transceiver and the remote control panel circuit analog-to-digital converter. That is why the remote control panel circuit does not require power voltage stabilizing.

The remote control panel and electronic tailcap circuits carry out data exchange through duplex radio channel. The channel is generated between the remote control panel antenna connected with the remote control panel radio transceiver and the electronic tailcap circuit antenna, connected with the electronic tailcap circuit radio transceiver.

In the manual control mode the light power on/off is preferably performed by pressing the electronic tailcap circuit control button is placed on the tailcap. Pressing and holding the electronic tailcap circuit control button initiates smooth changing of the lamp light brightness (adjusting of pulse-duration modulation signal duration is perform). When the required brightness is achieved it is necessary to release the button and the selected level of brightness will remain. The peak brightness level is achieved by the second pressing and holding the control button of the remote control panel circuit.

Such light lamp control is directed by the light control program certified under No 20086137773. The electronic tailcap circuit microcontroller functions in accordance with this program.

The manual control is carried out in most cases in accordance with the manual control mode table presented below.

| | Initial light | | |
|---|---|---|---|
| No | condition | Action | Light response |
| 1 | Off | One press | On |
| 2 | On | One press | Off |
| 3 | Off | Double press | Power on + remote control on/off |
| 4 | On | Double press | Power off + remote control on/off |
| 5 | Off | Hold button | Power on + brightness control on/off |
| 6 | On | Hold button | Off |

In the remote control mode the light may be controlled both with the electronic tailcap circuit control button and with remote control panel circuit control button. Switching into the remote control mode is preferably carried out with double short-time pressing the electronic tailcap circuit control button. In this case the electronic tailcap circuit microcontroller generates a pulse-duration modulation signal with increased duration pulse and the light will flash once.

Deactivation of the remote control mode is performed through double short-time pressing the electronic tailcap circuit control button. The electronic tailcap circuit microcontroller will generate a pulse-duration modulation signal with extended pulse duration and the light will flash twice.

At actuation of the light from the remote control panel circuit control button the appropriate signal is generated by the remote control panel circuit microcontroller controlled by the light remote control panel program certified under No 200861374. This signal is transmitted by the remote control panel circuit radio transceiver through the remote control panel circuit antenna via radio channel to the electronic tailcap circuit antenna connected to the electronic tailcap circuit radio transceiver. The electronic tailcap circuit microcontroller starts generating of pulse-duration modulation signal which comes to the electronic switch through which power voltage comes to the light lamp from the light lamp power battery. After actuation of the light lamp voltage at the voltage divisor falls to the level corresponding to the light lamp actuation and the value of this voltage comes to the electronic tailcap circuit microcontroller through the electronic tailcap circuit AD converter. The electronic tailcap circuit AD converter transmits the actuation confirmation signal to the remote control panel circuit microcontroller through the electronic tailcap circuit radio transceiver and the electronic tailcap circuit antenna via radio channel through the remote control panel circuit antenna and the remote control panel circuit radio transceiver. At absence of the light lamp actuation confirmation signal the remote control panel circuit microcontroller generates the light actuation signal again and transmits it to the electronic tailcap circuit. Thus the light actuation signal will bi transmitted from the remote control panel circuit until the electronic tailcap circuit microcontroller transmits the light lamp actuation confirmation signal to the remote control panel circuit microcontroller. This mode allows providing of the submitted equipment high reliability in the remote control mode.

While this invention has been particularly shown and described with references to preferred embodiments thereof, it will be understood by those skilled in the art that various changes in form and details may be made therein without departing from the scope of the invention encompassed by the appended claims.

What is claimed is:

1. A light-control device comprising:
a light lamp comprising a first lamp terminal and a second lamp terminal;
a light lamp battery comprising a positive lamp battery terminal and a negative lamp battery terminal;
a tailcap circuit, comprising:
an electronic switch,
a voltage stabilizer comprising an input and an output,
a voltage divisor comprising a power input, an input and an output,
a tailcap circuit analog-to-digital converter,
a tailcap circuit microcontroller comprising a pulse-duration modulation regulation input, a power input, a power output, a data input/output, and a control output,
a tailcap circuit memory module,
a tailcap circuit control button,
a tailcap circuit radio transceiver comprising a power input and a data input/output, and
a tailcap circuit antenna; and
a remote control circuit, comprising
a remote control circuit power battery comprising a positive remote control battery terminal and a negative remote control battery terminal,
a remote control circuit control button,
a remote control circuit analog-to-digital converter,
a remote control circuit microcontroller comprising a data input/output and a power output,
a remote control circuit memory module,
a remote control circuit radio transceiver comprising a data input/output and a power input, and
a remote control device circuit antenna;
wherein the positive lamp battery terminal is connected to the first lamp terminal;
wherein the second lamp terminal is connected to the negative lamp battery terminal through the electronic switch;
wherein the second lamp terminal is connected to the voltage divisor's input;
wherein the voltage divisor's output is connected to the pulse-duration modulation regulation input of the tailcap circuit microcontroller through the tailcap circuit analog-to-digital converter;
wherein the tailcap circuit control button is connected to the microcontroller;
wherein the voltage stabilizer, the tailcap circuit microcontroller, and the voltage divisor are connected to the negative lamp battery terminal;
wherein the control input of the electronic switch is connected to the control output of the tailcap circuit microcontroller;
wherein the power input of the tailcap circuit microcontroller is connected to the voltage stabilizer's output;
wherein the tailcap circuit microcontroller is connected to the tailcap circuit memory module;
wherein the voltage stabilizer's input is connected to the voltage divisor's power input;
wherein the data input/output of the tailcap circuit microcontroller is connected to the data input/output of the tailcap circuit radio transceiver;
wherein the power output of the tailcap circuit microcontroller is connected to the power input of the tailcap circuit radio transceiver;
wherein the tailcap circuit radio transceiver is connected to the tailcap circuit antenna;
wherein the remote control circuit power battery, the remote control circuit control button, the remote control circuit analog-to-digital converter, and the remote control circuit microcontroller are connected in series;
wherein the remote control circuit microcontroller's data input-output is connected to the remote control circuit radio transceiver's data input-output;
wherein the remote control circuit microcontroller's power output is connected to the remote control circuit radio transceiver's power input;
wherein the remote control circuit radio transceiver is connected to the remote control device circuit antenna;
wherein the remote control circuit microcontroller is connected to the negative remote control battery terminal and to the remote control circuit memory module;
wherein a remote light-control program is installed in the remote control circuit memory module; and
wherein the remote control circuit antenna is in duplex radio communication with the tailcap circuit antenna.
